(19) United States
(12) Patent Application Publication
(10) Pub. No.: US 2015/0197446 A1
(43) Pub. Date: Jul. 16, 2015

(54) GLASS MOLDED ARTICLE AND METHOD FOR PRODUCING SAME, OPTICAL ELEMENT BLANK, AND OPTICAL ELEMENT AND METHOD FOR PRODUCING SAME

(71) Applicants: Mikio Ikenishi, Tokyo (JP); Shizuo Suzuki, Tokyo (JP); Natthasit Wongwee, Amphur Muang (TH); Jiraporn Lungjai, Amphur Muang (TH)

(72) Inventors: Mikio Ikenishi, Tokyo (JP); Shizuo Suzuki, Tokyo (JP); Natthasit Wongwee, Amphur Muang (TH); Jiraporn Lungjai, Amphur Muang (TH)

(73) Assignees: HOYA OPTICS (THAILAND) LTD., Amphur Muang, Lamphun (TH); HOYA CORPORATION, Tokyo (JP)

(21) Appl. No.: 14/415,403

(22) PCT Filed: Jul. 11, 2013
(86) PCT No.: PCT/JP2013/068995

§ 371 Date: Jan. 16, 2015

(30) Foreign Application Priority Data
Jul. 18, 2012 (JP) 2012-159454

(51) Int. Cl. C03C 17/22; C03C 17/23; G02B 3/00; C03B 11/00

(52) U.S. Cl. CPC C03C 17/22; C03B 11/00; C03C 17/23; G02B 3/00

(57) ABSTRACT

When heating a glass gob including optical glass containing phosphorus, oxygen and fluorine to a temperature at which press-molding is possible, there are many cases in which the surface of the glass gob crystallizes and hardens. The problem of surface crystallization of glass gobs when press-molding is particularly prominent with glass to be polished and subjected to press-molding at a high temperature. This method for producing a glass molded article includes a step for covering the surface of a glass gob, which includes optical glass containing phosphorus, oxygen and fluorine, with a covering agent containing phosphorus, and a step for heating, softening and molding the glass gob covered by the covering agent.

The present invention relates to a glass molded article made of an optical glass (fluorophosphate glass) comprising phosphorous, oxygen and fluorine and the production method thereof and also relates to an optical element blank and optical element and the production method thereof.

### DESCRIPTION OF THE RELATED ART

As the method of producing the optical element made of glass such as lens or so, there is a method of forming the optical element having a shape close to the optical element, then grinding and polishing to form the optical element. As the method of producing the glass molded article, for example, the method of preparing the glass gob made of uniform optical glass, then heating said glass gob to soften thereby producing the glass molded article may be used.

Specifically, in JP Patent Application Laid Open No. 2007-210863 (the patent article 1), the method of producing the optical element blank having the shape close to the shape of the optical element by the press-molding, and processing the optical element blank thereby producing the optical element is described.

### PRIOR ART

### Patent Article

Patent Article 1: JP Patent Application Laid Open No. 2007-210863

### DISCLOSURE OF INVENTION

### Problem to be Solved by the Invention

When heating the glass gob made of the optical glass comprising phosphorous, oxygen and fluorine to the temperature which is possible to carry out the press molding, in many cases, the surface of the glass gob crystallize and cures. For the high performance optical lens glass such as a high refractive index low dispersion glass or an ultra low dispersion glass or so which were developed recently, a crystallization of the surface of the glass gob during the press-molding is significant.

When the glass gob comprising a cured coating due to the crystallization of the surface, the cured coating is embedded into the inside of the glass gob, thus the obtained glass molded article becomes non-uniform from the surface to the deeper part. The non-uniform glass molded article as such needs to remove the non-uniform part of the cured coating or so, which has been embedded, by grinding or polishing or so. As a result, the material waste increases and the production cost increases as well.

Thus, the heating temperature of the glass gob was lowered by lowering the temperature of the glass surface or reducing the high temperature maintaining time, thereby suppressing the crystallization of the glass surface.

However, when the heating temperature of the glass gob is lowered and press-molded, cracks may be occurred to the glass, or the temperature distribution in the glass gob becomes large or so thereby it cannot be molded to the desired shape.

In view of such condition, the production method of high quality glass molded article which suppress the crystallization of the glass surface during the molding while without lowering the heating temperature of the glass gob made the optical glass comprising phosphorous, oxygen and fluorine are in need, and also the production method of the glass molded article with little loss of the glass material is in need as well.

### Means for Solving the Problems

The present inventors has speculated that the selective crystallization at the glass surface during the heating and softening of the glass gob made of the optical glass comprising phosphorous, oxygen and fluorine may be caused by the phenomena wherein fluorine at the glass gob surface is exchanged with the oxygen in the air, thereby causing the decline of the fluorine content at the glass gob surface. Thus, in order to prevent the crystallization on the surface of the glass gob, the content of the phosphorous at the surface of the glass gob is increased where the fluorine content has declined thereby it was found that the crystallization of the glass gob surface can be prevented.

The present invention provides the glass molded article and the production thereof as described in below.

[1] A production method of a glass molded article comprising

a step A of coating a coating agent comprising phosphorous to a surface of a glass gob comprising an optical glass comprising phosphorous, oxygen and fluorine, and

a step B of heating, softening and molding said glass gob coated with said coating agent.

[2] The production method of the glass molded article as set forth in [1], wherein, in said step B, said glass gob is heated at a temperature so that a viscosity of a glass constituting said glass gob is 10⁶ dPa·s or less.

[3] The production method of the glass molded article as set forth in [1] or [2], wherein said coating agent comprises one or more component selected from the group consisting of phosphoric acid, phosphates and phosphorous oxide.

[4] The production method of the glass molded article as set forth in any one of [1] to [3], wherein said coating agent is made from a solution.

[5] The production method of the glass molded article as set forth in any one of [1] to [4], wherein said coating agent is made from phosphoric acid aqueous solution.

[6] The production method of the glass molded article as set forth in any one [1] to [5], wherein said step B comprises a press molding step.

[7] A glass molded article obtained by the production method as set forth in any one [1] to [6].

[8] A glass molded article made of an optical glass comprising phosphorous, oxygen and fluorine, wherein a content of phosphorous in a surface layer of said glass molded article is larger than the content of phosphorous at inside of said glass molded article.

[9] The glass molded article as set forth in [8], wherein thickness of said surface layer is 1 to 100 μm.

[10] An optical blank made of the glass molded article as set forth in any one of [7] to [9].

[11] An optical element made of the glass molded article as set forth in any one [7] to [9].

[12] A production method of an optical element comprising a step C of further processing the optical element blank as set forth in [10].

[13] The production method of the optical element as set forth in [12], wherein said step C comprises a step of removing the surface layer of said optical element blank.

### The Effect of the Invention

By using the production method of the glass molded article of the present invention, the cured layer of the glass surface by the crystallization during the heating and softening can be suppressed, and can prevent the deterioration of the optical uniformity of inside of the glass which is caused by the cured layer entering to the inside of the glass by molding. As a result, by using the present invention, the high quality glass molded article can be produced. Also, by the production method of glass molded article of the present invention, the waste of the glass material can be made little, and the glass molded article and the optical element can be produced in a low cost.

### BRIEF DESCRIPTION OF DRAWINGS

Hereinafter, the embodiments of the glass molded article of the present invention and the production method thereof will be described.

The production method of the glass molded article of the present invention comprises

a step A of coating a coating agent comprising phosphorous to a surface of a glass gob made of an optical glass comprising phosphorous, oxygen and fluorine, and

a step B of heating, softening and molding said glass gob of which said coating agent has been coated.

### 1 Glass Gob

The glass gob made of the optical glass comprising phosphorous, oxygen and fluorine used in the present invention is produced by the known method.

As the first example of the production method of the glass gob made of the optical glass comprising phosphorous, oxygen and fluorine, an uniform molten glass is produced by melting, refining and stirring the glass raw material, then the glass block is prepared by casting in the mold, then this glass block is annealed to obtain the glass piece by cutting in a cubic shape, and the glass gob can be produced which has same weight and shape made of each optical glass by carrying out the barrel polishing.

As the second example of the production method of the glass gob, there is the method wherein the glass column having the columnar shape is molded by casting the molten glass comprising phosphorous, oxygen and fluorine in the mold of cylinder shape, and the glass column molded in the mold is drawn out in vertically downward direction at a constant speed from the opening part of the mold bottom part, then the glass column is gradually cooled, then a glass piece having approximate circular shape is obtained by cutting or dividing, and this glass piece is carried out with the polish processing or barrel polishing thereby the glass gob is produced. The drawing speed may be carried out so that the molten glass level in the mold is constant.

As the third example of the production of the glass gob, there is the method wherein the molten glass produced by melting, refining and stirring the glass raw material comprising phosphorous, oxygen and fluorine is drained out, and while the molten glass flow draining out is received by the molding die, the amount of the molten glass gob necessary for the production of the glass molded article is separated and received in the molding die, thereby producing the glass gob. The glass gob produced as such has suitable shape and weight for the press-molding, thus it is possible to carry out the press-molding without the barrel polishing as mentioned in the above method; however it is possible to carry out the press-molding after carrying out the barrel polishing. Also, the molding die which receives the glass is not particularly limited, and it may be a float molding (the mold having a structure wherein the concave part receiving the molten glass is formed of porous materials, and the gas was spurted out from the surface of the concave part via the porous material), or it may be a mold having a saucer shape which is simple formed at the receiving part of the concave shape.

The composition of the glass molded article and the glass constituting the glass gob used in the present invention is not particularly limited as long as it is an optical glass (so called “fluorophosphate glass”) comprising phosphorous, oxygen and fluorine. As for the optical glass comprising phosphorous, oxygen and fluorine, the glass comprising 3 cation % or more and less than 50 cation % of P⁵⁺, g to 80 anion % of O²⁻, and 20 to 95 anion % of F⁻ can be mentioned as an example. In addition to the above mentioned components, alkali earth metal components, alkali metal components and rare earth components or so may be comprised appropriately.

### 2 Step of Coating the Coating Agent to the Surface of the Glass Gob (Step A)

In step A of the present invention, the coating agent comprising phosphorus is coated on the glass gob made of an optical glass comprising phosphorous, oxygen and fluorine.

As the coating agent comprising phosphorous, it is not particularly limited as long as it comprises phosphorous, and phosphorous itself, compound of phosphorous or the composition including phosphorous or so may be mentioned. As the compound of the phosphorous, for example, phosphoric acid (including phosphoric acids such as pyrophosphoric acid), phosphates (for example, phosphate alkaline salts, ammonium phosphate salts or so), oxides (for example, phosphorous pentaoxide or so), halogen compounds, organophosphorous compounds or so may be mentioned. As the composition including phosphorous, the combination of the above mentioned compounds of phosphorus, the solution dissolved with phosphoric acid, phosphates or phosphorous oxide or so in the water or the organic solvent or so may be mentioned.

Preferably, the coating agent comprises one or more components selected from the group consisting of phosphoric acid, phosphates and phosphorous oxide or so. The embodiment of the coating agent is not particularly limited, and it may be solid or liquid.

Also, as the liquid coating agent, it is preferably a solution comprising one or more component selected from the group consisting of phosphoric acid, phosphates and phosphorous oxide. As the solvent of such solution, water or organic solvent or so may be mentioned. Among these, as the liquid coating agent, phosphoric acid aqueous solution is preferable.

In case of using the solid coating agent, it is preferable to use by processing into a powder form, so that it is easy to adhere to the surface of the glass gob evenly. Such powder can be adhered to the glass gob by the method of scattering, spraying and rubbing or so. As the example of the powder coating agent, phosphoric acid may be mentioned.

The particle diameter of the powder coating agent is preferably 5 to 100 μm, and more preferably 10 to 50 μm.

In case of using the liquid coating agent, it is preferable to use the solution dissolving a compound of phosphoric acid, phosphates and phosphoric oxide or so, or the composition comprising at least one of these. Among these, the aqueous solution dissolving phosphoric acid, phosphates and phosphorous oxide in water is preferable. In case the coating agent is a solution, preferably the glass gob is immersed in the container with the solution, or the solution is adhered to the glass gob surface by coating the solution by spraying or brushing.

The concentration of the coating agent of the aqueous solution is preferably 1 to 30 wt %, more preferably 1 to 20 wt %. Also, in case the coating agent is phosphoric acid aqueous solution, it is preferably 1 to 20 wt %, and more preferably 1 to 10 wt %.

When the optical glass comprising phosphorous, oxygen and fluorine is heated for softening, the glass gob surface may not vitrify, and the phenomena of forming the cured coating may take place in some cases. Such phenomena is thought to be caused by the reduction of the fluorine content on the glass gob surface which is caused by the phenomena that the fluorine of the glass gob surface made of the optical glass comprising phosphorous, oxygen and fluorine being exchanged with oxygen in the air.

When the glass gob coated with the coating agent comprising phosphorous is heated and softened, phosphorous permeates to the glass gob. As a result, the surface of the glass gob has the composition with larger amount of the content of the phosphorous compared to the inside of the glass gob. The glass having the composition with large content of phosphorous has the property which hardly crystallizes even when it is heated. Therefore, the crystallization of the glass gob surface can be prevented effectively.

The coating agent is preferably coated to the face where the crystallization is to be suppressed during the heating and softening, and more preferably to the entire surface of the glass gob.

Note that, after the coating agent is coated to the surface of the glass gob, the releasing agent of powder form can be further coated so that the glass gob does not fuse to the molding die (for example, “the lower mold 60” and “the upper mold 61” described in the patent article 1) or the glass gob mounting member (for example, “the softening tray 10” described in the patent article 1) where the heated glass gob is placed on. The releasing agent is coated by the known method.

The releasing agent may be used by combining with the coating agent, or it may be coated after the coating agent. As the releasing agent, for example the powder form releasing agent such as boron nitride, alumina, silicon oxide, magnesium oxide or so may be mentioned.

### 3 Step of Heating, Softening and Molding the Glass Gob (Step B)

In the step B of the present invention, the glass gob coated with the coating agent is heated, softened and molded; thereby the glass molded article is obtained.

(1) The Softening of the Glass Gob

In the step of heating and softening the glass gob, the glass gob coated with the coating agent on the surface is placed on the heat resistant glass gob mounting member, and it can be carried out by introducing the glass gob mounting member into the heating device (for example, “the softening furnace 30” described in the patent article 1). When the glass gob coated with the coating agent is heated, the softened glass gob becomes a softened state, phosphorous included in the coating agent on the glass gob surface permeates to the glass gob, and the surface of the glass gob will form a composition having larger content of phosphorous than inside of glass gob. As such, the surface layer having large amount of phosphorous is formed at the surface of the glass gob.

The content of phosphorous of the surface layer of the glass gob is preferably 1.2 times more compared to the content of phosphorous at inside of the glass gob, and preferably 10 wt % or more higher.

Such glass having a composition with large content of phosphorous has a property that hardly crystallizes even when heated, thus the crystallization of the glass gob can be significantly suppressed.

The thickness of the surface layer is not limited, however the thickness sufficient enough to suppress the crystallization of the glass gob surface is necessary, and preferably it is 1 to 100 μm, and more preferably it is 5 to 50 μm.

In order to mold the desired shape without breaking the glass, the heating and the softening of the glass prior to the molding is preferably carried out by the heating at the temperature so that the viscosity of the glass becomes 10⁶ dPa·s or less, and it is more preferable to carry out the heating at the temperature so that the viscosity of the glass becomes 10⁵ dPa·s or less. According to the present invention, the devitirification of the glass surface is suppressed even when the glass is heated and softened to such viscosity.

It is preferable to coat the aqueous solution of phosphoric acid, phosphates or phosphorous oxide as the coating agent to the glass gob surface. In case the coating agent is liquid such as aqueous solution or so, the glass gob is immersed in the liquid, and the coating agent is coated to the glass gob by using the means of spraying the liquid, or pasting the liquid by brush or so. After the coating, it is preferable to use by drying to the level that the coating agent is not fluidized.

When the aqueous solution dissolved with these phosphoric acid, phosphates and phosphorous oxide are coated to the glass gob as the coating agent, and heated, then the contained water and the bound water in the coating agent is removed, and the solvent melts at the temperature equal to or lower than the softening temperature of the glass. For example, when phosphoric acid aqueous solution is coated to the glass gob as the coating agent and heated, the phosphoric acid in the coating agent undergoes dehydration condensation on the surface of the glass gob and melts.

Also, in case the solid coating agent such as phosphoric acid or so is coated to the glass as the coating agent, it is preferable to coat the glass powder which is processed into a powder form to the glass gob surface. In case the coating agent is a powder, the coating agent can be coated to the glass gob by using the method of passing through the glass gob in the powder, or sprinkling, spraying and rubbing or so the powder over the glass gob. In order for the glass powder to adhere to the glass gob, the component facilitating the adherence to the surface of the glass gob may be added. For example, when the powder of phosphoric acid is coated as the coating agent and heated, phosphoric acid melts on the surface of the glass gob.

As such, by coating the coating agent comprising phosphoric acid, phosphates and phosphorous oxide before heating, phosphorous comprised in the coating agent permeate to the glass gob; and the surface of the glass gob will have the composition with larger content of phosphorous compared to the inside of the glass gob. As such, at the surface of the glass gob, the surface layer having large content of phosphorous is formed, and the crystallization of the glass gob surface can be prevented effectively. As a result, it prevents the cured layer entering to the inside of the glass by the molding of after the heating, thus the optical uniformity of inside of the glass can be maintained. Also, by using the present invention, the glass material can be used efficiently, and the production yield of the glass molded article is improved.

(2) Molding

The method of molding the soften glass is not particularly limited, and known methods such as a press-molding method, a rolling method of molding the glass into a rod shape by placing the glass gob between plurality of rotating rollers, and a stretching method or so can be used.

In case of using the press-molding method, the glass gob is heated for softening, and the softened glass gob is applied with the pressure by press-mold die inside the press molding device, thereby it is molded into a desired shape.

As the press-molding device used for the press-molding method, the known ones can be used. For example, as the press-molding device, those comprising the molding die with the upper mold, the lower mold or body mold if needed, and the pressure applying system to apply the pressure to the upper mold and the lower mold can be mentioned. As the number of the molds, it may be set according to the number of the glass gob supplied at the same time as the glass gob mounting member. When supplying the glass gob to the molding die, the upper mold is moved to the upper side, and while under this condition, the glass gob is supplied on the lower mold. When the supply of the glass mold onto the lower mold is completed, the upper mold is lowered, and the mold is closed, then the softened glass gob is pressed by the upper and the lower mold. Then, the glass is transferred to the molding face of the upper and the lower molds (including the case of using the body mold and transferring the glass to the inner face of the body mold), then the glass molded article having the desired shape can be obtained.

Next, the glass molded article is taken out from the press-molding die by releasing, and the annealing treatment is carried out. By this annealing treatment, the strain inside the glass is reduced, and the optical characteristic such as refractive index or so can be a desired value.

As the heating condition of the glass gob, the molding condition and the material used for the press-molding die, those already known can be used. The above mentioned steps are carried out in the air.

The obtained glass molded article can be mainly used suitably as the optical element blank. The optical element blank is a glass blank having the shape close to the shape of the optical element of the object, and by grinding and polishing this, the optical element can be produced at the end.

Also, by carrying out the above mentioned press-molding method in high accuracy (the precision press-molding method), the glass molded article which can be used for the optical element can be obtained. In this case, the optical element can be obtained without the polish processing to the glass molded article, hence the production efficiency is high, and also the material loss due to the processing is little. Note that, in case of producing the glass molded article by the precision press-molding method, among the production method of the glass gob discussed in above, the glass gob (preform) obtained by the float molding as described in the third example is preferably used.

### 4 The Glass Molded Article

The glass molded article of the present embodiment is a glass molded article made of the optical glass comprising phosphorous, oxygen and fluorine, wherein the content of phosphorous at the surface layer of the glass molded article is larger than the content of phosphorous at inside of the glass molded article. Here, “the inside” is the inside in the thickness direction of the glass molded article (the deeper part), and the part present further inner side than the surface layer of the glass molded article.

Such glass molded article has larger content of phosphorous at the surface layer than the content of phosphorous at the inside of the glass molded article thus surface is difficult to be crystallized during the molding, and the deterioration of uniformity due to the cured coating can be suppressed.

Preferably, the content of phosphoric acid of the surface layer at the glass molded article is +1 cation % or more, more preferably, +10 cation % or more, further preferably +20 cation % or more, even more preferably +30 cation % than the inside of the glass gob. The upper limit of the content of phosphoric acid of the surface layer of the glass molded article is preferably +90 cation %, more preferably +80 cation %, further preferably +70 cation % than the inside of the glass gob.

According to such glass molded article, when producing the glass product having high uniformity such as optical element or so, the removed amount of the surface of the glass molded article can be reduced, thus the material waste and the production cost can be reduced. Also, in case the entire glass molded article is uniform, the glass molded article can be used as the optical element.

The glass molded article of the present embodiment can be produced by the production method of the glass molded article of the above.

The thickness of the surface layer of the glass molded article is preferably 1 μm or more from the point of suppressing the crystallization of the surface. On the other hand, from the point of reducing the removed amount when processing the glass molded article, the thickness of the above mentioned surface layer is preferably 100 μm or less. The more preferable lower limit of the thickness of the surface layer is 5 μm, and more preferable upper limit is 50 μm.

For the glass molded article of the present embodiment, the inner part is uniform, and the crystallization of the surface is suppressed, thus it is suited for the optical element or the optical blank.

### 5 The Step of Processing the Optical Element Blank (Step C)

The glass molded article obtained through the step A and the step B can be further processed by the known processing method such as the grinding or polishing. Here, the glass molded article is the optical element blank.

The shape of the glass molded article is molded close to the optical element, and further by carrying out the grinding and/or the polishing, the optical element such as lens and prism or so can be produced.

The method of grinding and/or polishing can be for example carried out by going through the following steps.

(i) The Grinding Step

The glass molded article is ground by using the diamond grind stone so that the shape becomes close to the shape of the optical element of the object.

(ii) The Polishing Step

The face ground in the above mentioned grinding step is polished using the loose grain such as cerium oxide or so.

(iii) The Finishing Polish Step

The polished face is finishing polished using zirconia.

By carrying out such steps, the glass molded article is processed, and the optical element can be produced.

During the processing of the step C, the surface layer of the glass molded article is removed by polishing or grinding, and the uniform glass molded article based on the glass gob is preferably obtained.

Note that, in the production method of the glass molded article of the present invention, the step C is not the essential step, and for example the glass molded article molded in the step B can be used as the optical element.

According to the present invention, the glass molded article can be produced in a good productivity, and further by using the glass molded article, the optical element such as lens and prism or so can be produced stably.

### 6 The Optical Element

As the optical element obtained by processing the glass molded article of the present invention, various lens such as spherical lens, aspherical lens, micro lens or so, diffraction gratings, lens with the diffraction gratings, lens array, prism or so can be mentioned. As from the aspect of the usage, the lens constituting the image optical system such as digital still camera, digital video camera, a single lens reflex camera, mobile phone mounted camera, automobile mounted camera or so; or the lens constituting the optical system for carrying out the data writing to the optical disk such as DVD or CD can be mentioned.

Depending on the needs, the optical thin film can be provided such as the anti-reflection film, total reflection film, partial reflection film, or the film having the spectral characteristics or so.

Hereinabove, the present invention was described based on the embodiment of the present invention, however the present invention is not to be limited thereto, and obviously various embodiments can be carried out within the range which does not exceed the scope of the present invention.

### EXAMPLE

The present invention will be described further specifically based on the examples. However, the present invention is not to be limited thereto.

### Examples 1 to 6, Comparative Examples 1 and 2

### The Production of the Glass Molded Article

(1) The Production of the Glass Gob

In order to produce two types of the optical glasses (the optical glasses 1 and 2) comprising the compositions and characteristics shown in Table 1, the glass raw materials were prepared, then each glass raw material were melted, refined and stirred to produce the uniform molten glass, and it was drained out from the draining pipe. While the tip of the molten glass flow of being drained out is received by the molding die, the necessary amount of the molten glass gob for producing the glass molded article was separated and received on the molding die. The gas was spouted from the molding die, and the gas pressure of upward direction was applied to the molten glass gob on the molding die, then it was molded into a glass gob while floating. As such, the glass gobs of the optical glasses 1 and 2 of two types were produced.

TABLE 1

| | | Optical glass 1 | Optical glass 2 |
|---|---|---|---|
| Cation | P⁵⁺ | 28.0 | 6.1 |
| components | Al³⁺ | 21.2 | 31.6 |
| (cation %) | Mg²⁺ | 6.5 | 5.5 |
| | Ca²⁺ | 14.5 | 27.7 |
| | Sr²⁺ | 17.2 | 16.6 |
| | Ba²⁺ | 11.9 | 4.5 |
| | Li⁺ | 0.0 | 4.8 |
| | Na⁺ | 0.0 | 2.0 |
| | K⁺ | 0.0 | 0.0 |
| | Y³⁺ | 0.7 | 1.2 |
| | Total | 100.0 | 100.0 |
| Anion | O²⁻ | 37.8 | 10.7 |
| Component | F⁻ | 62.2 | 89.1 |
| (anion %) | Cl⁻ | 0.0 | 0.2 |
| | Total | 100.0 | 100.0 |

| | | |
|---|---|---|
| Refractive index (nd) | 1.497 | 1.437 |
| Abbe number (vd) | 81.6 | 95.1 |
| Softening | 490 | 444 |
| temperature (° C.) | | |

(2) The Production of the Glass Molded Article

Each glass gob of the optical glasses 1 and 2 was immersed in the aqueous solution (the coating agent) shown in Table 2, and the surface of the glass gob were coated with the coating agent.

Using the optical glasses 1 and 2, each glass gob of which the surface is coated with the coating agent was placed on the softening tray of the glass gob mounting member, and then by placing in the softening furnace, the glass gob was heated and softened (examples 1 to 6). The temperature of the softening furnace was 100° C. higher than the softening temperature of the glass gob, and the time that the glass gob was maintained in the softening gob was 10 minutes.

Note that in the present specification, “the softening temperature” refers to the temperature at which the viscosity of the glass becomes 10^{7.6} dPa·s, and it is also called “Littleton temperature”. In the present specification, “the softening temperature” refers to the temperature measured by the method in accordance to JIS R 3103-1:2001.

Once each glass gob is softened, the glass gob was taken out from the softening furnace. At the surface of the glass gob of the examples 1 to 6 heated in the softening furnace, the melted coating agent was formed so that it covers the surface of the softened glass gob, and the component of the coating agent was in a condition to permeate to the glass gob.

TABLE 2

| | | | Heating temperature | |
|---|---|---|---|---|
| | Glass used for the glass | | during the molding | Surface of glass molded |
| | gob | Coating agent | (° C.) | article |
| Example 1 | Optical glass 1 | Phosphoric acid aqueous | 590 | Not devitrified |
| | | solution (18 wt %) | | (no crystallization) |
| Example 2 | Optical glass 2 | Phosphoric acid aqueous | 544 | Not devitrified |
| | | solution (18 wt %) | | (no crystallization) |
| Example 3 | Optical glass 1 | Phosphoric acid aqueous | 590 | Not devitrified |
| | | solution (9 wt %) | | (no crystallization) |
| Example 4 | Optical glass 2 | Phosphoric acid aqueous | 544 | Not devitrified |
| | | solution (9 wt %) | | (no crystallization) |
| Example 5 | Optical glass 1 | Phosphoric acid aqueous | 590 | Not devitrified |
| | | solution (5 wt %) | | (no crystallization) |
| Example 6 | Optical glass 2 | Phosphoric acid aqueous | 544 | Not devitrified |
| | | solution (5 wt %) | | (no crystallization) |
| comparative | Optical glass 1 | None | 590 | Devitrified (crystallized) |
| example 1 | | | | |
| comparative | Optical glass 2 | None | 544 | Devitrified (crystallized) |
| example 2 | | | | |

Next, the glass gob on the softening tray was introduced in to the press-molding die for press-mold. The molding face of the press-molding die has a shape wherein the surface of the glass molded article (the optical element blank) to be obtained is reversed. Note that, the heating temperature during the molding are as shown in Table 2.

Then, the glass molded article (the optical element blank) obtained by press-molding as such was taken out from the molding die. When the surface of the glass molded article was observed, the surface of the glass molded article of the examples 1 to 6 were not crystallized, and the cured coating due to the crystallization was not formed. Also, the cured coating was not embedded into the inside of the glass molded article as well. Further, the glass molded article of the examples 1 to 6 did not devitrify.

Note that, in the examples 1 to 6, boron nitride powder was coated together with the aqueous solution (the coating agent) shown in Table 2 to the surface of the glass gob, the glass gob was heated, softened and press-molded as same as the examples 1 to 6, thereby the glass molded article was produced. For the glass molded article produced as such, no crystallization was formed on any of the surface, and cured coating due to the crystallization was not formed as well. Also, the cured coating was not embedded into the inside of the glass molded article. Also, the inside of each glass molded article did not devitrify.

On the other hand, in the comparative examples 1 and 2, except for not using the coating agent, the glass molded article (the optical element blank) was produced by each glass gob of the optical glasses 1 and 2 under the same condition as the examples 1 to 6.

For the glass molded article of the comparative examples 1 and 2 wherein the glass gob was not coated with the coating agent were also observed for the surface of the obtained glass molded article as similar to the examples to 1 to 6, however the crystallization was formed on the surface of the glass molded article, and the cured coating was formed. Also, the glass molded articles obtained from the comparative examples 1 and 2 were devitrified.

(3) The Content of the Phosphorous in the Surface Layer and the Inside of the Glass Molded Article

The composition of the outer most surface and the inside of the glass molded article were analyzed by X-ray photoelectron spectroscopy (XPS).

When the composition of the inside of the glass molded article is analyzed by XPS, the glass molded article is ground till the part to be analyzed is exposed, and the composition of the ground face is analyzed. Therefore, in case of carrying out the analysis at any of the outer most surface or the ground face of the glass molded article, the elements such as C and N or so may be detected as the contaminant. In such case, for calculating the content of phosphorous from the analysis result of XPS, the contamination of C and N or so are excluded.

When the surface of the glass molded article produced by coating the boron nitride to the glass gob surface is analyzed by XPS, B and N will be detected. The boron nitride functions as the releasing agent, and it does not suppress the crystallization of the glass surface, thus B and N at the surface layer is used as the contaminant. Therefore, for calculating the content of phosphorous from the analysis result of XPS, B, N and C are excluded.

The measurement condition by XPS is as follows.

Excitation X-rays: A1 mono
Detection range: φ100 μm
Extraction angle: 45 deg
Detection depth: 4 to 5 nm
Spattering condition: Ar⁺ 2.0 kV
Spattering rate: about 5 nm/min (in terms of SiO₂)

At the outer most surface of each glass molded article of examples 1 to 6 which are molded by only coating phosphoric acid aqueous solution, although there is a variation depending on the places, the amount of P⁵⁺ calculated from the analysis result of XPS exceed 50 cation %.

Next, 30 μm of the surface of each glass molded article of examples 1 to 6 were ground, then the composition of the ground face were analyzed by XPS, then the amount of P⁵⁺ exceeded 50 cation %.

Further, 50 μm of the surface of each glass molded article of examples 1 to 6 were ground, then the composition of the ground face were analyzed by XPS under the same condition as the above mentioned measuring condition, and for the composition of each glass molded articles of examples 1, 3 and 5, it was the same as the composition of the optical glass 1 shown in Table 1; and for the composition of each glass molded articles of the examples 2, 4 and 6, it was the same as the composition of the optical glass 2 shown in Table 1. That is, the amount of P⁵⁺ at 50 μm inside from the surface of each glass molded article of the examples 1, 3 and 5 were about 28 cation %; and the amount of P⁵⁺ at 50 μm inside from the surface of each glass molded article of the examples were about 6.1 cation %.

Further, the surface of the glass molded article was ground for 1 mm, 2 mm and 5 mm, then each ground face were analyzed respectively by XPS under the same condition as the abovementioned measuring condition, and the glass molded articles of the examples 1, 3 and 5 had the same composition as the optical glass 1 shown in Table 1; and the glass molded articles of the examples 2, 4 and 6 had the composition were as same as the optical glass 2 shown in Table 1.

As such, for the glass molded articles of examples 1 to 6, the content of the phosphorous at the surface layer were confirmed to be larger than the content of the phosphorus at the inside of the glass molded article.

Also, in the glass molded article of examples 1 to 6, the content of phosphorous at the outer most surface and the ground face at the depth of 30 μm from the outer most surface were larger than the content of phosphorous at the deeper part having the depth of 50 μm or more; and since the content of phosphorous at the deeper part having the depth of 50 μm or more has the constant composition, the thickness of the surface layer of the glass molded article can be said to be 30 μm or more and less than 50 μm.

Next, in the examples 1 to 6, boron nitride powder were coated together with the phosphorous aqueous solution to the surface of the glass gob, and the glass gob was heated, softened and press-molded as same as the examples 1 to 6 to produce the glass molded article, then the content of phosphorous were analyzed by XPS. In any of the glass molded article, the content of phosphorus at the surface layer was larger than the content of phosphorous at the inside of the glass molded article. Also, the thickness of the surface layer of the glass molded article was 30 μm or more and less than 50 μm.

### Examples 7 to 12

### The Production of the Spherical Lens

The glass molded article (the lens blank) of the example 1 was annealed so that the optical characteristic matches with the optical characteristic of the object lens, and also the strain in the glass was reduced. Then, by the known methods, the lens blank was ground and polished for processing, and the spherical lens was produced (example 7).

As similar to the example 7, each spherical lens of the examples 8 to 12 were produced from each glass molded article (the optical element blank) of examples 2 to 6.

The spherical were produced in the examples 7 to 12, however other optical element such as prims can be produced from the glass molded article of the examples 1 to 6.

Finally, the embodiment of the present invention will be summarized.

[1] The production method of the glass molded article of the present embodiment comprises a step A of coating a coating agent comprising phosphorous to a surface of a glass gob made of an optical glass comprising phosphorous, oxygen and fluorine, and

a step B of heating, softening and molding said glass gob of which said coating agent has been coated.

[2] Preferably, in the production method of the glass molded article as set forth in above mentioned [1], in said step B, said glass gob is heated at a temperature so that a viscosity of a glass constituting said glass gob is 10⁶ dPa·s or less.

[3] Preferably, in the production method of the glass molded article as set forth in above mentioned [1] or [2], said coating agent comprises one or more component selected from the group consisting of phosphoric acid, phosphates and phosphorous oxide.

[4] Preferably, in the production method of the glass molded article as set forth in any one of [1] to [3], said coating agent is made from a solution.

[5] Preferably, in the production method of the glass molded article as set forth in any one of [1] to [4], said coating agent is made of phosphoric acid aqueous solution.

[6] Preferably, in the production method of the glass molded article as set forth in any one of [1] to [5], said step B comprises a press molding step.

[7] Preferably, the glass molded article according to the present embodiment is obtained by the production method of the glass molded article as set forth in any one of [1] to [6].

[8] In other aspect, the glass molded article of the present embodiment is a glass molded article made of an optical glass comprising phosphorous, oxygen and fluorine, wherein

a content of phosphorous in a surface layer of said glass molded article is larger than the content of phosphorous at inside of said glass molded article.

[9] Preferably, in the glass molded article as set forth in above [8], the thickness of said surface layer is 1 to 100 μm.

[10] In other aspect, the optical element blank of the present embodiment is made of the glass molded article as set forth in any one of above [7] to [9].

[11] In other aspect, the optical element of the present embodiment is made of the glass molded article as set forth in any one of above [7] to [9].

[12] In other aspect, the production method of the optical element of the present embodiment comprises step C of further processing the optical element blank as set forth in [10].

[13] Preferably, in the production method of the optical element as set forth in [12], said step C comprises a step of removing the surface layer of said optical element blank.

Further, in other aspect of the present embodiment,

[A1] The production method of the glass molded article of the present embodiment comprises a step A of coating a coating agent comprising phosphoric acid, phosphates and phosphorous oxide or a composition comprising these to a surface of a glass gob made of an optical glass comprising phosphorous, oxygen and fluorine, and

a step B of heating, softening and molding said glass gob of which said coating agent has been coated.

[A2] Preferably, in the production method of the glass molded article as set forth in above mentioned [A1], in said step B, said glass gob is heated at a temperature so that a viscosity of a glass constituting said glass gob is 10⁶ dPa·s or less.

[A3] Preferably, in the production method of the glass molded article as set forth in above [A1] or [A2], the coating agent comprises one or more component consisting of groups of phosphoric acid, phosphates, phosphorous oxide and the aqueous solution dissolved therewith.

[A4] Preferably, in the production method of the glass molded article as set forth in [A1] or [A2], said coating agent is made of phosphoric acid aqueous solution.

[A5] Preferably, in the production method of the glass molded article as set forth in any one of [A1] to [A4], said step B comprises a press molding step.

[A6] Preferably, in the production method of the glass molded article as set forth in any one of above [A1] to [A5], the glass molded article comprises the surface layer at the surface of the glass gob, and

a content of the phosphorous of the surface layer is larger than the content of phosphorous at the center part of the glass gob.

[A7] Preferably, the production method of the glass molded article of the present embodiment further comprise the step C of processing the obtained glass molded article by the production method of the glass molded article as set forth in any one of above [A1] to [A6].

[A8] Preferably, the production method of the glass molded article of the present embodiment further comprises the step C of removing the surface layer by processing the glass molded article obtained by the production method of the glass molded article as set forth in above [A6].

[A9] Preferably, in the production method of the glass molded article as set forth in any one of [A1] to [A8], the glass molded article is the optical element or the optical element blank.

[A10] In other aspect, the glass molded article of the present embodiment is the glass molded article of the glass gob made of the optical glass comprising phosphorous, oxygen and fluorine, wherein the content of phosphorous at the surface layer formed the surface of the glass gob is larger than the content of the phosphorous at the center part of the glass gob.

[A11] Preferably, in the glass molded article as set forth in above [A10], the thickness of said surface layer is 1 to 100 μm.

[A12] Preferably, in the glass molded article as set forth in above [A10] or [A11], the glass molded article is the optical element or the optical element blank.

### INDUSTRIAL APPLICABILITY

The glass molded article of the present invention can be used as the optical element such as lens or prism or so.

1. A production method of a glass molded article comprising
a step A of coating a coating agent comprising phosphorous to a surface of a glass gob comprising an optical glass comprising phosphorous, oxygen and fluorine, and
a step B of heating, softening and molding said glass gob coated with said coating agent.

2. The production method of the glass molded article as set forth in claim 1, wherein, in said step B, said glass gob is heated at a temperature so that a viscosity of a glass constituting said glass gob is 106 dPa·s or less.

3. The production method of the glass molded article as set forth in claim 1, wherein said coating agent comprises one or more component selected from the group consisting of phosphoric acid, phosphates and phosphorous oxide.

4. The production method of the glass molded article as set forth in claim 1, wherein said coating agent is made from a solution.

5. The production method of the glass molded article as set forth in claim 1, wherein said coating agent is made from phosphoric acid aqueous solution.

6. The production method of the glass molded article as set forth in claim 1, wherein said step B comprises a press molding step.

7. A glass molded article obtained by the production method as set forth in claim 1.

8. A glass molded article made of an optical glass comprising phosphorous, oxygen and fluorine, wherein
a content of phosphorous in a surface layer of said glass molded article is larger than the content of phosphorous at inside of said glass molded article.

9. The glass molded article as set forth in claim 8, wherein thickness of said surface layer is 1 to 100 μm.

10. An optical blank made of the glass molded article as set forth in claim 7.

11. An optical element made of the glass molded article as set forth in claim 7.

12. A production method of an optical element comprising a step C of further processing the optical element blank as set forth in claim 10.

13. The production method of the optical element as set forth in claim 12, wherein said step C comprises a step of removing the surface layer of said optical element blank.
